(19) United States
(12) Patent Application Publication
(10) Pub. No.: US 2019/0336390 A1
(43) Pub. Date: Nov. 7, 2019

(54) METHODS AND APPARATUS FOR GENERATING GAS BUBBLES

(71) Applicant: Aqua Pur Tubs Incorporated, Bumaby (CA)

(72) Inventor: Nathan Adam FISHMAN, Langley (CA)

(21) Appl. No.: 16/414,692

(22) Filed: May 16, 2019

Related U.S. Application Data
(63) Continuation of application No. PCT/CA2017/051375, filed on Nov. 17, 2017.
(60) Provisional application No. 62/424,288, filed on Nov. 18, 2016.

(51) Int. Cl. A61H 33/02; B01F 3/04; B01F 3/08; B01F 5/02; B01F 5/04; B01F 5/10

(52) U.S. Cl. CPC A61H 33/027; B01F 3/0451; B01F 3/04262; A61H 2033/145; B01F 5/0206; B01F 5/0476; B01F 5/106; B01F 3/0876

(57) ABSTRACT

A bubble-generating apparatus comprises: a casing defining a casing bore extending longitudinally therethrough; and a diffuser located in the casing bore, the diffuser defining a diffuser bore extending longitudinally therethrough. The diffuser bore comprises a fluid-input region at or near a fluid-input end of the diffuser and a fluid-output region at or near a fluid-output end of the diffuser. A cross-sectional area of the diffuser bore in the fluid-input region is greater than the cross-sectional area of the diffuser bore in the fluid-output region. At least a portion of the diffuser is porous for permitting a flow of pressurized gas from a region of the casing bore located outside of the diffuser bore, through the porous portion of the diffuser and into the diffuser bore.

### REFERENCE TO RELATED APPLICATIONS

This application is a continuation of Patent Cooperation Treaty (PCT) application No. PCT/CA2017/051375 having an international filing date of 17 Nov. 2017, which in turn claims priority from, and the benefit under 35 USC 119(e) from, U.S. application No. 62/424288 filed 18 Nov. 2016. PCT application No. PCT/CA2017/051375 and U.S. application No. 62/424288 are hereby incorporated herein by reference.

### TECHNICAL FIELD

Particular embodiments of this invention relate to methods and apparatus for generating gas bubbles and diffusing same in a liquid volume. Some embodiments relate to methods and apparatus for generating nano-sized gas bubbles, more particularly, for generating carbonic acid from mixing carbon dioxide with water. Particular embodiments relate to methods for local delivery of carbonic acid gas to patients (e.g. on their epidermis) for therapeutic applications.

### BACKGROUND

The therapeutic application of carbonic acid gas to humans is known. Carbonic acid gas is typically generated by mixing carbon dioxide with water in a chamber and passing the mixture through a porous membrane prior to discharge from the chamber and into a water volume. Carbonic acid then spreads throughout the water volume (e.g. a tub or the like), where a patient may be located. Typically, prior art carbonic acid treatments require water volume to have a pH level of between 4.2 and 5.2 for therapeutic efficacy.

Conventional gas bubble generators are inefficient and expensive to operate. In particular, existing carbonic acid gas diffusers are slow to create carbonic acid due to inefficient mixing of CO₂ into the water volume or otherwise and, consequently, require relatively large amounts of expensive carbon dioxide gas, particularly for therapeutic applications, where prior art diffusers are used to lower the pH level of an entire volume of water (e.g. a tub or the like) to the typical range of 4.2 to 5.2. There is thus a general desire for an improved apparatus and method for generating and disbursing carbonic acid in water. There is also a general desire for an efficient and cost-effective gas bubble generator that addresses or at least ameliorates some of the aforementioned drawbacks with the prior art gas bubble generators.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides an apparatus for generating gas bubbles. The bubble-generating apparatus comprises: a casing defining a casing bore extending longitudinally therethrough; and a diffuser located in the casing bore, the diffuser defining a diffuser bore extending longitudinally therethrough. The diffuser bore comprises a fluid-input region at or near a fluid-input end of the diffuser and a fluid-output region at or near a fluid-output end of the diffuser. A cross-sectional area of the diffuser bore in the fluid-input region is greater than the cross-sectional area of the diffuser bore in the fluid-output region. At least a portion of the diffuser is porous for permitting a flow of pressurized gas from a region of the casing bore located outside of the diffuser bore, through the porous portion of the diffuser and into the diffuser bore.

Another aspect of the invention provides a method for generating gas bubbles in a liquid. The method comprises: providing a bubble generator comprising: a casing defining a casing bore extending longitudinally therethrough; and a diffuser located in the casing bore, the diffuser defining a diffuser bore extending longitudinally therethrough, the diffuser bore comprising a fluid-input region at or near a fluid-input end of the diffuser and a fluid-output region at or near a fluid-output end of the diffuser, a cross-sectional area of the diffuser bore in the fluid-input region greater than the cross-sectional area of the diffuser bore in the fluid-output region. At least a portion of the diffuser is porous for permitting a flow of pressurized gas from a region of the casing bore located outside of the diffuser bore, through the porous portion of the diffuser and into the diffuser bore. The casing comprises a gas-input opening which provides fluid communication with a portion of the casing bore located outside of the diffuser bore. The method also comprises: connecting the fluid-input region of the diffuser bore to receive a liquid at sufficient pressure to create a pressure gradient of the liquid in the diffuser bore to cause the received liquid to flow longitudinally in the diffuser bore toward the fluid-output region of the diffuser bore; and connecting the gas-input opening to receive gas at a pressure higher than the pressure of the liquid in the diffuser bore, such that the gas received at the gas-input opening moves from the casing bore, permeates the porous portion of the diffuser and enters the diffuser bore to mix with the liquid flowing longitudinally in the diffuser bore and the mixture of liquid and gas bubbles exits the fluid-output region of the diffuser bore.

Another aspect of the invention provides a method of delivering localized carbonic acid to a patient's skin. The method comprises: supplying carbon dioxide and water to a bubble generator to create a flow comprising a mixture of water and carbon dioxide gas in a form of bubbles comprising diameters in a range of about 10 nm to about 1000 nm, the flow discharged from the bubble generator and into a tub of water; and locating a patient in the tub of water. Locating the patient in the tub of water may comprise causing physical interactions between the patient's skin and the carbon dioxide bubbles and thereby attracting the carbon dioxide bubbles to a region around the patient's skin. Attracting the carbon dioxide bubbles to the region around the patient's skin may comprise creating a corresponding localized region around the patient's skin of pH that is lower than a pH of a bulk of the water in the tub.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic view of a gas bubble delivery system according to a particular example embodiment.

FIG. 2 schematically illustrates the flow of liquid and gas into and out of a gas bubble generator according to a particular example embodiment.

FIG. 3 is a partially exploded perspective view of a gas bubble generator shown with its casing removed according to a particular example embodiment.

FIG. 4A is a perspective exploded view of the FIG. 3 gas bubble generator. FIG. 4B is a perspective exploded view of the FIG. 3 gas bubble generator with its components shown as transparent.

FIG. 5 is a partially exploded perspective view of the FIG. 3 gas bubble generator with its casing removed and with its components shown as transparent.

FIG. 6 is another partially exploded perspective view of the FIG. 3 gas bubble generator with its casing removed and with its components shown as transparent.

FIG. 7A is a photograph of the skin of a patient suffering from eczema before gas bubble treatment. FIG. 7B is a photograph of the skin of the same patient suffering from eczema after gas bubble treatment taken five days later after two twenty minute sessions per day in the FIG. 1 gas bubble delivery system.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides an apparatus for generating gas bubbles. The bubble-generating apparatus comprises: a casing defining a casing bore extending longitudinally therethrough; and a diffuser located in the casing bore, the diffuser defining a diffuser bore extending longitudinally therethrough. The diffuser bore comprises a fluid-input region at or near a fluid-input end of the diffuser and a fluid-output region at or near a fluid-output end of the diffuser. A cross-sectional area of the diffuser bore in the fluid-input region is greater than the cross-sectional area of the diffuser bore in the fluid-output region. At least a portion of the diffuser is porous for permitting a flow of pressurized gas from a region of the casing bore located outside of the diffuser bore, through the porous portion of the diffuser and into the diffuser bore.

Another aspect of the invention provides a method for generating gas bubbles in a liquid. The method comprises: providing a bubble generator comprising: a casing defining a casing bore extending longitudinally therethrough; and a diffuser located in the casing bore, the diffuser defining a diffuser bore extending longitudinally therethrough, the diffuser bore comprising a fluid-input region at or near a fluid-input end of the diffuser and a fluid-output region at or near a fluid-output end of the diffuser, a cross-sectional area of the diffuser bore in the fluid-input region greater than the cross-sectional area of the diffuser bore in the fluid-output region. At least a portion of the diffuser is porous for permitting a flow of pressurized gas from a region of the casing bore located outside of the diffuser bore, through the porous portion of the diffuser and into the diffuser bore. The casing comprises a gas-input opening which provides fluid communication with a portion of the casing bore located outside of the diffuser bore. The method also comprises: connecting the fluid-input region of the diffuser bore to receive a liquid at sufficient pressure to create a pressure gradient of the liquid in the diffuser bore to cause the received liquid to flow longitudinally in the diffuser bore toward the fluid-output region of the diffuser bore; and connecting the gas-input opening to receive gas at a pressure higher than the pressure of the liquid in the diffuser bore, such that the gas received at the gas-input opening moves from the casing bore, permeates the porous portion of the diffuser and enters the diffuser bore to mix with the liquid flowing longitudinally in the diffuser bore and the mixture of liquid and gas bubbles exits the fluid-output region of the diffuser bore.

Another aspect of the invention provides a method of delivering localized carbonic acid to a patient's skin. The method comprises: supplying carbon dioxide and water to a bubble generator to create a flow comprising a mixture of water and carbon dioxide gas in a form of bubbles comprising diameters in a range of about 10 nm to about 1000 nm, the flow discharged from the bubble generator and into a tub of water; and locating a patient in the tub of water. Locating the patient in the tub of water may comprise causing physical interactions between the patient's skin and the carbon dioxide bubbles and thereby attracting the carbon dioxide bubbles to a region around the patient's skin. Attracting the carbon dioxide bubbles to the region around the patient's skin may comprise creating a corresponding localized region around the patient's skin of pH that is lower than a pH of a bulk of the water in the tub.

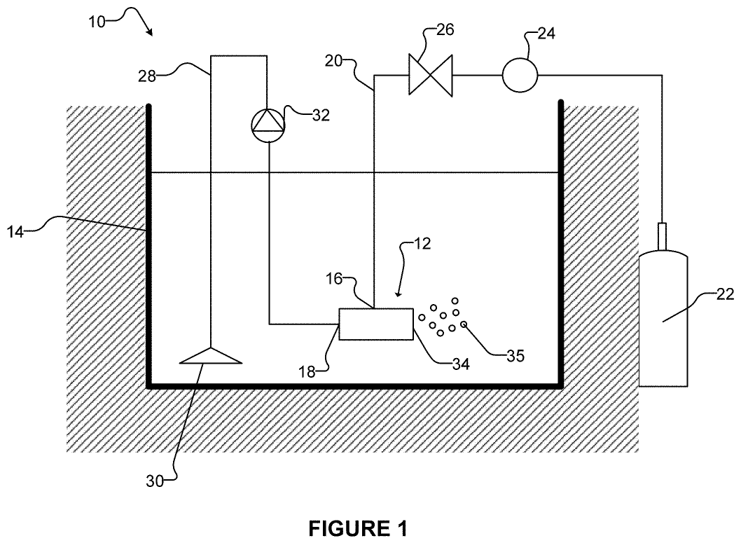

FIG. 1 is a schematic view of a gas bubble delivery system 10 according to a particular example embodiment. Gas bubble delivery system 10 comprises a gas bubble generator 12 placed inside a tank 14 filled (at least in part) with liquid (e.g. water). Tank 14 may be a bath tub, a hot tub and/or the like. Gas bubble generator 12 may be submerged in the liquid in tank 14. Gas bubble generator 12 comprises a gas-input opening 16 and a liquid-input opening 18 for receiving a flow of gas and liquid, respectively, into a body of generator 12. A mixture of gas and liquid, in the form of a plurality of gas bubbles 35, exit generator 12 from a fluid-output opening 34. When the plurality of gas bubbles 35 discharge from generator 12, they may spread and diffuse in the liquid volume inside tank 14.

In some embodiments, a gas supply line 20 connects a gas source 22 to gas-input opening 16 of the generator 12. Gas source 22 may be remote from tank 14. Gas source 22 may be pressurized or gas provided to gas-input opening 16 may be otherwise pressurized, so that gas is driven into bubble generator 12 by a pressure gradient. In some embodiments, gas source 22 comprises a gas cylinder, in which gas is stored under pressure. Alternatively, a compressor (not shown) may be operatively connected to gas source 22 and/or to supply line 20 to pressurize the gas for delivery into generator 12 via gas-input opening 16. A skilled person will appreciate that conventional fluid control components, such as, by way of non-limiting example pressure regulators 24 and control valves 26, may be connected to the gas supply line 20 for controlling various parameters (e.g. volume, flow rate, pressure and/or the like) of pressurized gas that flows into bubble generator 12 via gas-input opening 16. In some embodiments, the gas is carbon dioxide. In some embodiments, the pressurized gas that is delivered into generator 12 is under a pressure of approximately 500 to 4000 psi. In other embodiments, this pressure range is 1000 to 200 psi.

In some embodiments, a feed line 28 connects a liquid-source opening 30 to liquid-input opening 18 of bubble generator 12. Liquid pump 32 (and/or other fluid control components) may be operatively connected between liquid-source opening 30 and liquid-input opening 18 for supplying and controlling various parameters (e.g. volume, flow rate, pressure and/or the like) of liquid supplied to bubble generator 12. The pressure at which liquid is supplied to liquid-input opening 18 may be less than the pressure at which gas is supplied to gas-input opening 16. In some embodiments, pump 32 is not required because the supply of gas at gas-input opening 16 and/or the location of liquid-source opening 30 relative to liquid-input opening 18 (e.g. placing liquid-source opening 30 above liquid-input opening) can create pressure gradient that draws liquid through liquid-input opening 18. In some embodiments, the liquid supplied to generator 12 is water. In the illustrated embodiment, liquid-source opening 30 is located in the liquid contained in tank 14 to provide liquid from tank 14 to bubble generator 12. In some embodiments, liquid-source opening 30 can be located external to tank 14 (e.g. in a filtration system or the like (not shown) which removes liquid from tank 14 for filtration purposes). In some embodiments, liquid-source opening 30 may be connected to receive liquid from an external liquid source—i.e. a liquid source other than the liquid in tank 14. In some such embodiments, the rate of which water flows through feed line 28 into bubble generator 12 is in a range of about 1 to 10 gallons per minute, and the rate of which gas flows through gas supply line 20 into generator 12 is in a range of about 25 to 150 cc per minute at a pressure of approximately 1 to 100 psi, although operation outside of these ranges is possible.

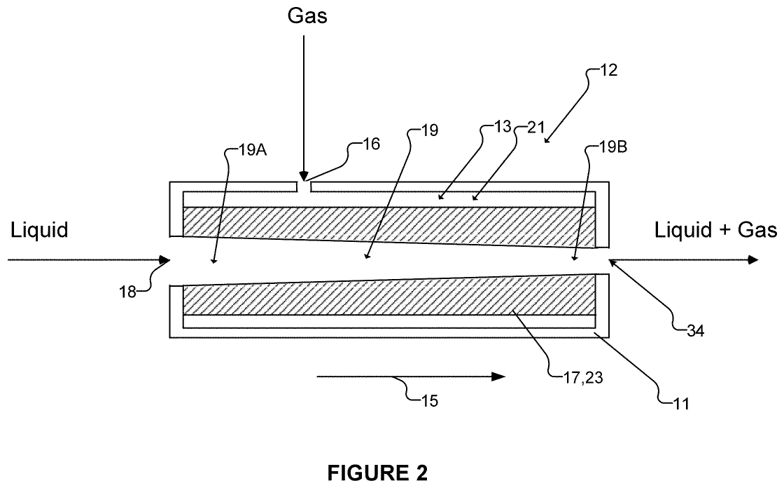

FIG. 2 schematically illustrates a bubble generator 12 and the flow of gas and liquid into and out of gas bubble generator 12 according to a particular embodiment. Bubble generator 12 of the FIG. 2 embodiment comprises a casing 11 which defines a casing bore 13 that extends in a longitudinal liquid-flow direction (shown by arrow 15) through casing 11. Bubble generator 12 also comprises a diffuser 17 located in casing bore 13. Diffuser 17 defines a diffuser bore 19 which extends in longitudinal direction 15 through diffuser 17. Diffuser bore 19 comprises a fluid-input region 19A and a fluid-output region 19B, where a cross-sectional area of the diffuser bore 19 (in a cross-section perpendicular to longitudinal liquid-flow direction 15) is greater at the fluid-input region 19A than at the fluid-output region 19B. At least a portion 23 of diffuser 17 is porous. Liquid enters bubble generator 12 from liquid-input opening 18, and gas enters bubble generator 12 from gas-input opening 16. In particular, liquid flows into fluid-input region 19A of diffuser bore 19 at or near liquid-input opening 18. Gas, which may be introduced to bubble generator 12 under pressure that is greater than the pressure of liquid in diffuser bore 19, flows into casing bore 13 through gas-input opening 16 and then, from a region 21 of the casing bore 13 located outside of diffuser 17 and its bore 19, through the porous portion 23 of diffuser 17 and into diffuser bore 19. Gas introduced into diffuser bore 19 thorough porous diffuser portion 23 mixes with the liquid inside bubble generator 12 and, in particular, with the liquid introduced into diffuser bore 19 from liquid-input opening 18. As a result, a gas and liquid mixture flows out of diffuser bore 19 and out of generator 12 from fluid-output opening 34. The output gas and liquid mixture comprises gas bubbles 35 (FIG. 1).

In some embodiments, the input liquid is water, and the input gas is carbon dioxide. In such embodiments, the gas and liquid mixture that exits bubble generator 12 may comprise carbonic acid or may generate carbonic acid. It is expected that at the exemplary ranges of input water and gas flow rates suggested herein, the change in pH of the bulk liquid held in tank 14 after the addition of gas bubbles will be less than about 0.1 (e.g. a pH of 6.9-7 in the case of water). In some embodiments, marginal decrease in pH of the bulk liquid held in tank 14 may be detected and/or monitored. In particular embodiments, the bulk liquid held in tank 14 after the addition of gas bubbles has a pH in the range of about 6 to less than 7. In some embodiments, the bulk liquid held in tank 14 after the addition of gas bubbles has a pH in the range of about 5.2 to 7.5.

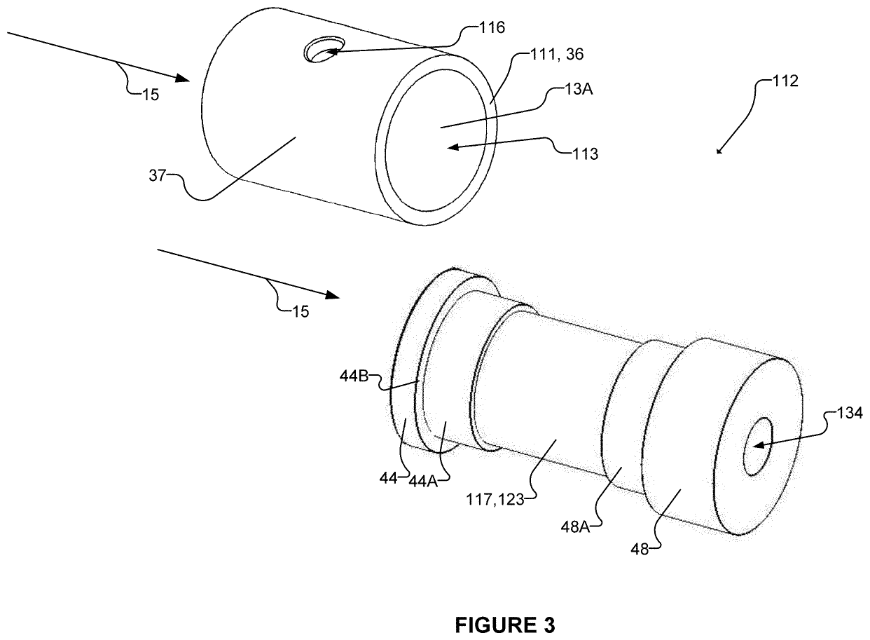

FIGS. 3 to 6 show a bubble generator 112 according to another particular embodiment. Bubble generator 112 shares many features in common with bubble generator 12 shown in FIG. 2 and similar reference numerals (differing by 100) are used to describe common features as between the two bubble generators 12, 112. Gas bubble generator 112 of the illustrated embodiment comprises a casing assembly 111 which itself comprises an elongated (in longitudinal fluid-flow direction 15) and generally cylindrical casing body 36, an input cap 44 and an output cap 48. Bubble generator 112 and the components of casing assembly 111 of the illustrated embodiment have generally annular cross-sections (perpendicular to longitudinal direction 15) to define a circular cross-section casing bore 113 that extends in longitudinal direction 15 through casing assembly 111. These shapes of the components of casing assembly 111 and casing bore 113 are not necessary. In some embodiments, bubble generator 12, the components of casing assembly 111 and/or casing bore 113 may have other cross-sectional shapes.

Input cap 44 and output cap 48 are connectable to casing body 36 at respective longitudinally opposing ends of casing body 36. In the illustrated embodiment, input cap 44 comprises a coupling surface 44A that is complementary to a portion of casing-bore defining surface 113A of casing body 36 and surfaces 44A and 113A can connect together via friction fit, by using suitable adhesive, suitable fasteners, combinations thereof and/or the like. In the particular case of the illustrated embodiment, coupling surface 44A of input cap may be inserted into casing bore 113 to abut against casing-bore defining surface 113A and a suitable adhesive may be used to complete the connection of these two surfaces. In the illustrated embodiment, input cap 44 also comprises a second coupling surface 44B that abuts against an input end of casing body 36 and a suitable adhesive may be used to complete the connection of these two surfaces. In the illustrated embodiment, output cap 48 comprises similar coupling surfaces 48A, 48B that may be similarly connected to casing body 36 at the opposing longitudinal end. In some embodiments, input cap 44 and output cap 48 may be connected to casing body 36 using other suitable techniques. The connections of input cap 44 and output cap 48 to casing body 36 may be impermeable to gas at the pressures of gas used in casing bore 113.

In some embodiments, casing assembly 111 (when assembled) comprises a length in a range of approximately ¼ to 6 inches. In some embodiments, casing assembly 111 (when assembled) comprises a length in a range of approximately 1 to 2 inches. The inventor considers that these ranges are flexible depending on the applications in which diffuser 112 is used. Lengths of up to several feet may be used in some applications. In some embodiments, casing bore 113 may have a cross-sectional area (perpendicular to longitudinal direction 15) in a range of approximately 0.25-30 square inches. In some embodiments, this size may be in a range of 0.5-4 square inches. Other suitable dimensions may be possible for other applications.

Casing body 36 of the illustrated embodiment defines a gas-input opening 116 which provides fluid communication between an outside of casing assembly 111 and casing bore 113. Gas-input opening 116 may comprise an aperture defined on a face 37 of casing body 36 which leads to casing bore 113. In some embodiments, the aperture of gas input opening 116 may have a cross-sectional area in a range of approximately 0.01 to 2.5 square inches, although other sizes of gas-input opening 116 may be used for other applications. In the illustrated embodiments, gas-input opening 116 is positioned at approximately halfway along the longitudinal dimension of casing body 36.

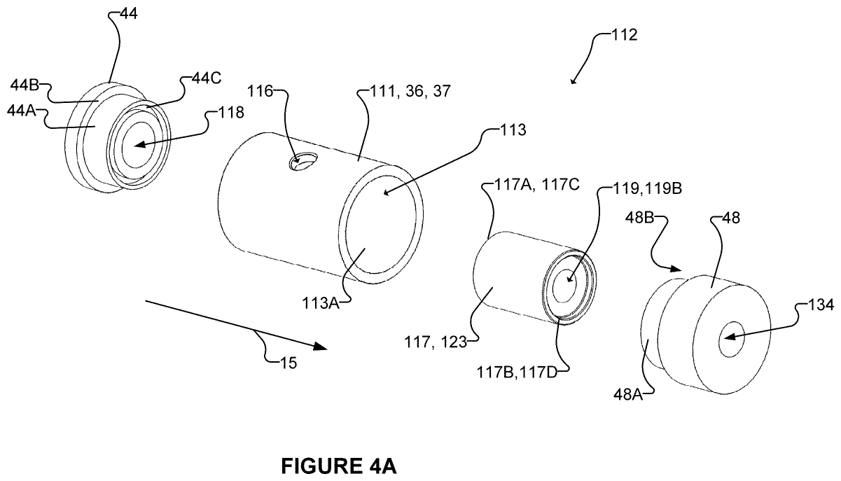

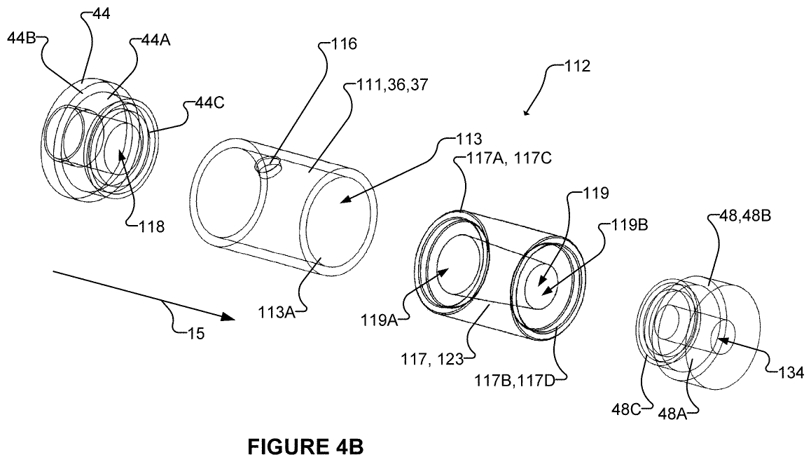

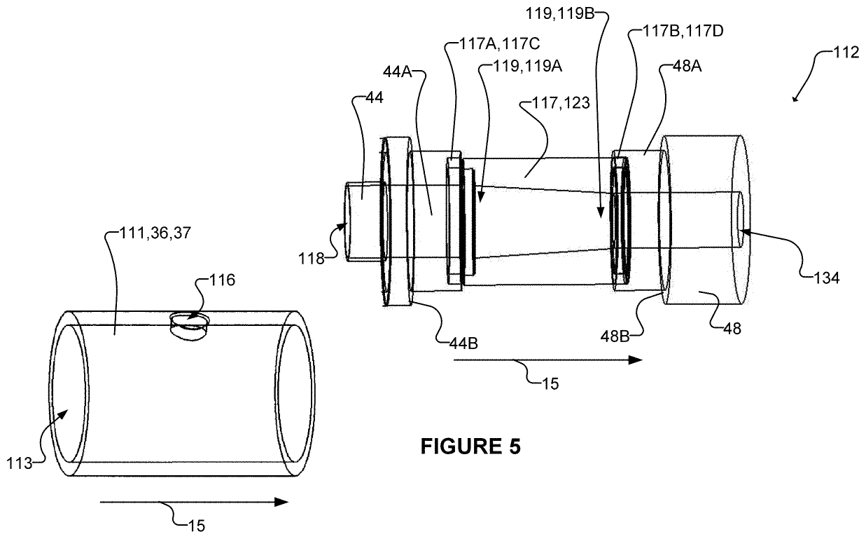

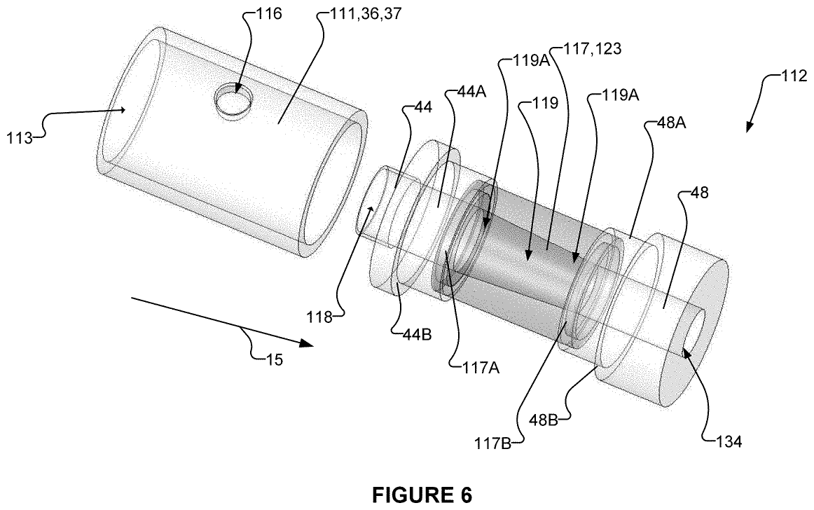

Bubble generator 112 also comprises a diffuser 117 which, when bubble generator is assembled, is located in casing bore 113 between input cap 44 and output cap 48. Diffuser 117 is shaped to define a diffuser bore 119 which extends in longitudinal direction 15 through diffuser 117. At least a portion 123 of diffuser 117 is porous to permit gas flow from an exterior of diffuser 117 through porous portion 123 and into diffuser bore 119 to create bubbles (e.g. nano-bubbles), as explained in more detail below. In some embodiments, porous portion 123 comprises pores having cross-sectional dimensions of less than 75 μm across. In some embodiments, porous portion 123 comprises pores having cross-sectional dimensions of less than 50 μm across. In some embodiments, porous portion 123 comprises pores having cross-sectional dimensions of less than 25 μm across. In the illustrated embodiment, porous portion 123 makes up all or substantially all of diffuser 117. Diffuser 117 is shaped such that diffuser bore 119 comprises a fluid-input region 119A (relatively close to input cap 44) and a fluid-output region 119B (relatively close to output cap 48) where fluid-input region 119A has a cross-sectional area (in a direction perpendicular to longitudinal direction 15) that is greater than the cross-sectional area of fluid-output region 119B (see FIG. 4B). In the particular case of the illustrated embodiment, diffuser bore 119 has a frustro-conical shape having a wide end at fluid-input region 119A and a narrow end at fluid-output region 119B and a smoothly angularly decreasing cross-sectional area with movement along longitudinal direction 15. As best shown in FIGS. 5 and 6, diffuser bore 119 of the illustrated embodiment tapers along the length of diffuser 117 from fluid-input region 119A to fluid-output region 119B at a constant diffuser bore angle. In some embodiments, the diffuser bore angle is in a range of approximately 0.5° to 45°. In some embodiments, the diffuser bore angle is in a range of approximately 2° to 20°. In some embodiments, the bore angle is in a range of approximately 3° to 10°.

When bubble generator 112 is assembled, an input end 117A of diffuser 117 may engage or be connected to input cap 44 and an output end 117B of diffuser 117 may engage or be connected to output cap 48. In the illustrated embodiment, input cap 44 comprises a channel 44C which is complementary in shape to a rim 117C on input end 117A of diffuser 117. Channel 44C opens in longitudinal direction for receiving rim 117C on input end 117A of diffuser 117 (see FIGS. 4B and 5). In some embodiments, input end 117A of diffuser 117 may be friction fit into channel 44C, adhesively connected to the surfaces in channel 44C, combinations thereof and/or the like, although this is not necessary. Output cap 48 may comprise a similar channel 48C (FIG. 4B) for engaging or connecting to output end 117B (e.g. to a rim 117D on output end 117B) of diffuser 117.

Input cap 44 is shaped to define a liquid-input opening 118 which, when bubble generator 112 is assembled, provides fluid communication between an exterior of casing assembly 111 to diffuser bore 119. Liquid-input opening 118 may have a cross-sectional area (perpendicular to longitudinal direction 15) that is the same size or larger than the cross-sectional area of diffuser bore 119 in fluid-input region 119A, although this is not necessary. Similarly, output cap 48 is shaped to define a fluid-output opening 134 which, when bubble generator 112 is assembled, provides fluid communication between diffuser bore 119 and an exterior of casing assembly 111. In the illustrated embodiment, fluid-output opening 134 has a cross-sectional area (perpendicular to longitudinal direction 15) that is the same size or smaller than the cross-sectional area of diffuser bore 119 in fluid-output region 119B, although this is not necessary.

Bubble generator 112 operates as follows. Liquid is provided to liquid-input opening 118 and pressurized gas is provided to gas-input opening 116, as discussed above in connection with bubble generator 12 of FIG. 2. Liquid (e.g. water) may be forced through liquid-input opening 118 by any suitable means of creating a pressure differential and enters diffuser bore 119 at or near fluid-input region 119A. Gas (e.g. carbon dioxide) may be forced through gas-input opening 116 by any suitable means of creating a pressure differential and enters the region 121 (FIG. 2) of casing bore 113 that is external to diffuser 117 and its diffuser bore 119. The gas, which may be introduced to bubble generator 112 at a higher pressure than the liquid introduced into diffuser bore 119, is forced from region 121 through the porous portion 123 of diffuser 117 and into diffuser bore 119, where the gas forms bubbles (e.g. nano-bubbles) in the liquid flowing through diffuser bore 119. The fluid mixture of liquid and gas bubbles (e.g. nano-bubbles) exits from diffuser bore 119 and from bubble generator 112 via fluid-output opening 134.

Without wishing to be bound to any theory, the inventors believe that providing diffuser bore 119 with a relatively larger cross-sectional area in fluid-input region 119A and a relatively smaller cross-sectional area in fluid-output region 1198, and/or the tapered shape of diffuser bore 119 between fluid-input region 119A and fluid-output region 1198, allows for increased efficiency in generating and disbursing of gas bubbles into a liquid volume. The relatively larger cross-sectional area of diffuser bore 119 at the fluid-input region 119A creates a large surface area of diffuser 117 for input gas to flow into diffuser bore 119. Consequently, a large volume of gas can be forced from region 121 of casing bore 113, through porous portion 123 of diffuser 117, and into diffuser bore 119. The relatively large surface area of diffuser 117 in fluid-input region 119A also creates lower fluid pressure inside diffuser 117, thereby reducing back pressure which would hinder the flow of fluid. The tapering of diffuser bore 119 (and/or the relative sizes of diffuser bore 119 in fluid-input region 119A and fluid-output region 1198) also increases fluid velocity as fluid travels in longitudinal direction 15 through diffuser bore 119 from fluid-input region 119A through to fluid-output region 119B, thereby increasing the amount of gas bubbles that may be introduced into the liquid traveling through diffuser bore 119 and diffused into the surrounding pool of liquid at a given time. The tapering of the diffuser bore 119 (and/or the relative sizes of diffuser bore 119 in fluid-input region 119A and fluid-output region 1198) relative to a constant bore size also reduces the resident time of bubbles on the bore-defining surface of diffuser 117 and thereby, maintains the size of bubbles at an acceptably small level. For example, bubbles with long residency time in diffuser 117 may become undesirably large.

In some embodiments, casing assembly 111 (including casing body 36, input cap 44 and/or output cap 48) are made of plastic, but could generally be made of other suitable materials that are capable retaining liquid. Diffuser 117 and/or the porous portion 123 of diffuser 117 may be made of any suitable porous material, including, but not limited to ceramic, metal, rayon, wood, bamboo, porous plastic, carbon material, graphite material, carbon-graphite composite material and/or other suitable materials. In some embodiments, porous portion 123 comprises pores having cross-sectional dimensions of less than 75 μm across. In some embodiments, porous portion 123 comprises pores having cross-sectional dimensions of less than 50 μm across. In some embodiments, porous portion 123 comprises pores having cross-sectional dimensions of less than 25 μm across.

Individual gas bubbles that are generated and diffused by various bubble-generator embodiments may comprise diameters in the nanometer or micrometer ranges. In particular embodiments, the size of individual gas bubbles may be in a range of about 10-1000 nm in diameter. In some embodiments, the size of individual gas bubbles may be in a range of about 10-300 nm in diameter. In some embodiments, the size of individual gas bubbles may be in a range of about 10-100 nm in diameter. One skilled in the art will appreciate that the size of the generated gas bubbles varies depending on the velocity of the liquid input into bubble generator 12, 112 and the pressure of the input gas that flow into bubble generator 12, 112 and on the characteristics of diffuser 17, 117, such as the pore size of the porous portion 23, 123 of diffuser 17, 117.

Another aspect of the invention relates to methods for delivery of carbonic acid via carbon dioxide gas bubbles to patients (e.g. humans or other animals) for therapeutic applications. Some embodiments provide methods for therapeutic delivery of carbonic acid via carbon dioxide gas bubbles having a diameter within the nanometer range to patients located inside a water volume. Particular embodiments relate to methods for therapeutic delivery (to humans or other animals) of carbonic acid via carbon dioxide gas bubbles using gas bubble generator 12 as discussed above.

In some embodiments, carbon dioxide gas bubbles are discharged from a gas bubble generator and then freely disperse in a water volume such as a bath tub, a hot tub and/or the like (e.g. the water in tank 14 (FIG. 1)), where they form carbonic acid in the water. The size of individual gas bubbles may be in a range of approximately 10 to 1000 nm in diameter. In some embodiments, the size of individual gas bubbles may be in a range of about 10-300 nm in diameter. In some embodiments, the size of individual gas bubbles may be in a range of about 10-100 nm in diameter. The size of the gas bubbles that are generated from the gas bubble generator is dependent upon the pore size of the membrane that is used for the diffuser of the generator.

Without bound to any theory, individual gas bubbles having diameters within the nanometer ranges discussed herein carry their own charges—e.g. negative charges. This charge of the carbon dioxide gas bubbles may interact electrostatically or otherwise (e.g. by van der Waals forces or the like) with the electrically charged skin of the patient, which is s typically hydrophilic and which typically has charged particles on its surface or otherwise exhibits surface charge. Consequently, the charged (e.g. negatively charged) gas bubbles adhere to, or are attracted to, the surfaces of the patient's skin and form a thin layer of carbon dioxide gas and/or a corresponding thin layer of carbonic acid on, and/or in a vicinity of, the skin. Without wishing to be bound by theory, the inventors consider that adherence of, or proximity of, the carbon dioxide gas bubbles to the patient's skin creates a localized carbonic acid zone of correspondingly low pH in a vicinity of the skin of the patient, thereby creating therapeutic pH levels at or around the patient without using as much carbon dioxide gas as prior art techniques, which involve large sized gas bubbles and lowering the pH of the entire volume of water in tub 14 (e.g. by introducing enough carbon dioxide to lower the pH of the entire volume of tub 14). Further, adherence of or proximity of the carbon dioxide gas bubbles to the human skin minimizes the spread of gas bubbles to other regions of the water volume. This is desirable since the spread of gas bubbles to regions away from the human body results in gas bubbles not being therapeutically exploited and thus wasted.

Typical therapeutic applications of carbonic acid involve exposing the patient's skin to acidic environments with a pH less than 7.0 and, in most cases, a pH below 5.2 and, in some cases, as low as 4.2 or lower. In accordance with some aspects of the invention, such a therapeutically useful acidic pH (i.e., pH less than 7.0, more preferably at around pH 4.2-5.2) would be created in a localized region of the water volume where the patient's body is located. For example, in some embodiments, this localized region is within 2.5 cm of the skin of the patient. In some this localized region is within 1 cm of the skin of the patient. In some this localized region is within 0.5 cm of the skin of the patient. The pH of the bulk of the remaining water volume in tank 14 (i.e. in the water spaced apart from the patient) would be much higher than 5.2. For example, in some embodiments, this bulk water region is spaced apart from the skin of the patient by more than 5 cm. In some embodiments, this bulk water region is spaced apart from the skin of the patient by more than 10 cm. In some embodiments, this bulk water region is spaced apart from the skin of the patient by more than 20 cm. In some cases, the pH of the bulk of the water in tank 14 (and spaced apart from the patient) may be greater than 5.5 while a patient is being treated with carbon dioxide bubbles in a localized region of low pH in an immediate vicinity the patient. In some cases, the pH of the bulk of the water in tank 14 (and spaced apart from the patient) may be greater than 6.5 while a patient is being treated with carbon dioxide bubbles in a localized region of low pH. In some cases, the pH of the bulk of the water in tank 14 (and spaced apart from the patient) may be greater than 6.8 while a patient is being treated with carbon dioxide bubbles in a localized region of low pH in an immediate vicinity of the patient. The delivery of localized acidic pH in a range of about pH 4.2-5.2 around a patient by the use of nano-sized carbon dioxide gas bubbles has at least the advantage of using low levels of input carbon dioxide (such as a carbon dioxide flow rate into the diffuser in a range of about 50 to 1000 cc/min) to achieve the therapeutic benefits to humans or animals. This is considered to be very low levels of input carbon dioxide as compared to prior art techniques involving larger volumes of carbon dioxide gas to lower the pH of the entire water volume in the tank. In particular, the inventors believe that its method could involve using only about 1% of the total carbon dioxide gas required by certain prior art techniques to achieve equivalent therapeutic benefits to humans or animals.

### EXPERIMENTAL EXAMPLE 1

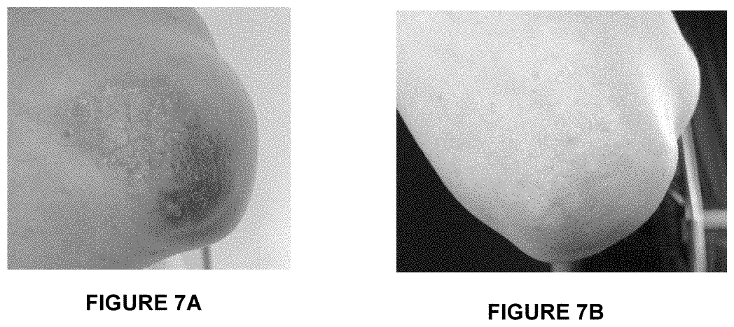

An experimental apparatus for gas bubble generator 12, 112 was tested on a patient who appears to suffer from eczema. Eczema, also known as atopic dermatitis, is a form a skin disease that causes the skin to become inflamed or irritated. FIG. 7A shows the eczema rash on the patient's elbow before gas bubble treatment.

A gas bubble generator 12, 112 was placed inside a bath tub 14. The taper angle of the diffuser bore 19, 119 between fluid-input region 19A, 119A and fluid-output region 19B, 119B was approximately 7.5°. The bath tub was filled with water after a sufficient amount of carbon dioxide gas has flown through diffuser 17, 117 so that generator 12, 112 was not saturated with water. Water and pressurized carbon dioxide gas were supplied into generator 12, 112 through their respective openings (see discussion above). A carbon dioxide flow control valve was operatively connected to control the flow of pressurized carbon dioxide gas into generator 12, 112. The pressurized gas that was delivered into generator 12, 112 created a pressure differential between the gas inside and the water outside of generator 12, 112 of about 29 psi. The rate at which the gas was supplied into generator 12,112 was maintained at approximately 75 cc/min. The gas bubbles discharged by generator 12, 112 were spread and diffused in the water volume where the patient's elbow was located. The temperature of the water volume was in the range of between 95 to 106° F. The water volume comprising the gas bubbles discharged by generator 12 under these conditions was reported, by the patient, to create a silky texture. Without bound to any theory, it is believed by the inventors that the silky texture in the water volume comprising gas bubbles helps to determine the efficacy of the gas bubble generator 12, 112 in the treatment of skin diseases.

FIG. 7B is a photograph of the skin of the same (FIG. 7A) patient suffering from eczema after gas bubble treatment taken six days later after two twenty minute sessions per day using the experimental bubble generating system under the specified conditions.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof; elements which are integrally formed may be considered to be connected or coupled;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

While a number of exemplary aspects and embodiments are discussed herein, those of skill in the art will recognize certain modifications, permutations, additions and sub-combinations thereof. For example:
In some embodiments, one or both of input cap 44 or output cap 48 may be integrally formed with casing body 36.
In some embodiments, gas-input opening 116 may be provided on one or both of input cap 44 and output cap 48 in addition to or in the alternative to being provided on casing body 36.

What is claimed is:

1. An apparatus for generating gas bubbles, the apparatus comprising:
a casing defining a casing bore extending longitudinally therethrough;
a diffuser located in the casing bore, the diffuser defining a diffuser bore extending longitudinally therethrough, the diffuser bore comprising a fluid-input region at or near a fluid-input end of the diffuser and a fluid-output region at or near a fluid-output end of the diffuser, a cross-sectional area of the diffuser bore in the fluid-input region greater than a cross-sectional area of the diffuser bore in the fluid-output region;
wherein at least a portion of the diffuser is porous for permitting a flow of pressurized gas from a region of the casing bore located outside of the diffuser and the diffuser bore, through the porous portion of the diffuser, and into the diffuser bore.

2. An apparatus according to claim 1 wherein the diffuser is shaped to provide the diffuser bore with a diffuser-bore shape that tapers smoothly, without discontinuities, along its longitudinal length between the fluid-input region and the fluid-output region.

3. An apparatus according to claim 1 wherein the diffuser bore is shaped to taper at a constant angle to provide the diffuser bore with a frustro-conical shape between the fluid-input region and the fluid output region.

4. An apparatus according to claim 2 wherein the diffuser bore is shaped to taper with an angle in a range of about 0.5° to about 45° between the fluid-input region and the fluid output region.

5. An apparatus according to claim 2 wherein the diffuser bore is shaped to taper at an angle in a range of about 3° to about 10° between the fluid-input region and the fluid output region.

6. An apparatus according to claim 1 wherein the diffuser is shaped to provide the diffuser bore with a diffuser-bore shape that comprises one or more discontinuities between the fluid-input region and the fluid-output region.

7. An apparatus according to claim 1 wherein the casing comprises:
an input cap at a first longitudinal end of the casing, the input cap defining a liquid-input opening which provides an entrance to the casing bore, the liquid-input opening in fluid communication with the fluid-input region of the diffuser bore;
an output cap at a second longitudinal end of the casing opposed from the first longitudinal end of the casing, the output cap defining a fluid-output opening which provides an egress from the casing bore, the fluid-output opening in fluid communication with the fluid-output region of the diffuser bore; and
a casing body extending longitudinally between the input cap and the output cap.

8. An apparatus according to claim 7 wherein the casing body is connected to the input cap and connected to the output cap.

9. An apparatus according to claim 8 wherein the casing body is connected to the input cap by one or more of a friction fit and adhesive bonding.

10. An apparatus according to claim 7 wherein the casing body is connected to the output cap by one or more of a friction fit and adhesive bonding.

11. An apparatus according to claim 8 wherein the connection of the casing body to the input cap is impermeable to the pressurized gas in the region of the casing bore located outside of the diffuser and the diffuser bore.

12. An apparatus according to claim 8 wherein the connection of the casing body to the output cap is impermeable to the pressurized gas in the region of the casing bore located outside of the diffuser and the diffuser bore.

13. An apparatus according to claim 7 wherein the casing body is integrally formed with one of the input cap and the output cap.

14. An apparatus according to claim 7 wherein a first longitudinal end of the diffuser is connected to the input cap via a first connection located within the casing bore and a second longitudinal end of the diffuser, opposed from the first longitudinal end of the diffuser, is connected to the output cap via a second connection located within the casing bore.

15. An apparatus according to claim 14 wherein the first connection comprises one or more of a friction fit and an adhesive bond.

16. An apparatus according to claim 14 wherein the second connection comprises one or more of a friction fit and an adhesive bond.

17. An apparatus according to claim 14 wherein the connection of the casing body to the input cap is impermeable to the pressurized gas in the region of the casing bore located outside of the diffuser and the diffuser bore.

18. An apparatus according to claim 14 wherein the connection of the casing body to the output cap is impermeable to the pressurized gas in the region of the casing bore located outside of the diffuser and the diffuser bore.

19. An apparatus according to claim 1 wherein the casing defines a gas-input opening which provides fluid communication with the region of the casing bore located outside of the diffuser and the diffuser bore.

20. An apparatus according to claim 7 wherein the casing body defines a gas-input opening which provides fluid communication with the region of the casing bore located outside of the diffuser and the diffuser bore.

21. An apparatus according to claim 7 wherein at least one of the input cap and the output cap defines a gas-input opening which provides fluid communication with the region of the casing bore located outside of the diffuser and the diffuser bore.

22. An apparatus according to claim 1 wherein the fluid-input region of the diffuser bore is connected to receive a liquid and a pressure gradient of the liquid in the diffuser bore causes the received liquid to flow longitudinally in the diffuser bore toward the fluid-output region of the diffuser bore.

23. An apparatus according to claim 19 wherein the fluid-input region of the diffuser bore is connected to receive a liquid and a pressure gradient of the liquid in the diffuser bore causes the received liquid to flow longitudinally in the diffuser bore toward the fluid-output region of the diffuser bore.

24. An apparatus according to claim 23 wherein the gas-input opening is connected to receive gas at a pressure higher than the pressure of the liquid in the diffuser bore, such that the gas received at the gas-input opening moves from the region of the casing bore located outside of the diffuser and the diffuser bore, permeates the porous portion of the diffuser and enters the diffuser bore to mix with the liquid flowing longitudinally in the diffuser bore.

25. An apparatus according to claim 24 wherein the fluid-output region is connected to discharge a mixture of the liquid and bubbles of the gas into a tub containing a bulk of the liquid.

26. An apparatus according to claim 25 wherein the liquid comprises water and the gas comprises carbon dioxide.

27. An apparatus according to claim 25 wherein a size of the bubbles is in a range of about 10 nm to about 1000 nm in diameter.

28. An apparatus according to claim 25 wherein a size of the bubbles is in a range of about 10 nm to about 100 nm in diameter.

29. A method for generating gas bubbles in a liquid, the method comprising:
providing a bubble generator comprising:
a casing defining a casing bore extending longitudinally therethrough;
a diffuser located in the casing bore, the diffuser defining a diffuser bore extending longitudinally therethrough, the diffuser bore comprising a fluid-input region at or near a fluid-input end of the diffuser and a fluid-output region at or near a fluid-output end of the diffuser, a cross-sectional area of the diffuser bore in the fluid-input region greater than a cross-sectional area of the diffuser bore in the fluid-output region;
wherein at least a portion of the diffuser is porous for permitting a flow of pressurized gas from a region of the casing bore located outside of the diffuser and the diffuser bore, through the porous portion of the diffuser, and into the diffuser bore;
wherein the casing comprises a gas-input opening which provides fluid communication with the region of the casing bore located outside of the diffuser and the diffuser bore;
connecting the fluid-input region of the diffuser bore to receive a liquid at sufficient pressure to create a pressure gradient of the liquid in the diffuser bore to cause the received liquid to flow longitudinally in the diffuser bore toward the fluid-output region of the diffuser bore; and
connecting the gas-input opening to receive gas at a pressure higher than the pressure of the liquid in the diffuser bore, such that the gas received at the gas-input opening moves from the region of the casing bore located outside of the diffuser and the diffuser bore, permeates the porous portion of the diffuser, and enters the diffuser bore to mix with the liquid flowing longitudinally in the diffuser bore and the mixture of liquid and gas bubbles exits the fluid-output region of the diffuser bore.
